(19) United States
(12) Patent Application Publication
(10) Pub. No.: US 2004/0177756 A1
(43) Pub. Date: Sep. 16, 2004

(54) Protection against pollen in the form of woven or knitted fabric for windows and doors

(76) Inventors: Andreas Schroder, Hamburg (DE); Claus Grobe, Hamburg (DE); Dieter Wenninger, Singapore (SG); Jens Kranz, Hamburg (DE)

Correspondence Address: CHRISTINA HILDEBRAND, NORRIS, MCLAUGHLIN & MARCUS, 220 EAST 42ND STREET - 30TH FLOOR, NEW YORK, NY, 10017, US

(21) Appl. No.: 10/380,735

(22) PCT Filed: Oct. 23, 2001
(86) PCT No.: PCT/EP01/12232

(30) Foreign Application Priority Data
Oct. 26, 2000 (DE) 10053229.2

(51) Int. Cl. B01D 46/00

(52) U.S. Cl. 95/273

(57) ABSTRACT

The use of woven or loop-formingly knitted fabrics for attachment in front of windows or doors to guard against dusty allergens such as pollen or dust, this pollen guard possessing by virtue of the generation of an electrostatic charge an adequate filtering performance with regard to pollen while at the same time meeting the properties of adequate visual transparency and adequate air perviousness.

This invention relates to woven or loop-formingly knitted apparatus for guarding against the penetration of dusty, airborne allergens such as pollen and fungal spores into living and working areas by attachment in front of windows and doors over the whole area thereof.

The incidence of pollinosis (hay fever), ie the allergic reaction of the mucous membranes of the eye and of the upper and lower respiratory tracts with flower pollen and other airborne allergens, in the population has been monitored in Germany for a number of years. It was found that about 11-15% of the population is affected. The allergic reaction of a pollen allergy usually manifests itself in reddening and lacrimation of the eyes (conjunctivitis), sneezing episodes (rhinitis) and a dry cough (bronchial asthma) as early reactions. Known late reactions to pollen allergy include for example neurodermatitis or eczema. As well as the personal symptoms, there are more far-reaching consequences such as loss of earnings or work incapacity during the pollen season or increased medical treatment costs, so that there is an immense need for a gridlike pollen guard within the meaning of the invention for attachment in front of the windows and offices of living and working areas. Further information about pollinosis is available in Ratgeber Pollenallergie, Ute Künkele, Munich 1992.

The most important properties a pollen guard for windows and doors must offer the user are: sufficient ability to air the amenities, sufficient transparency for letting light in and for looking out, and an alleviating effect with regard to pollen allergy. The most important parameters for describing a pollen guard are accordingly: air perviousness, optical transparency and filtering effect with regard to pollen.

Guard systems attached in front of windows and doors over the whole area thereof in order that the penetration of comparatively large objects such as insects into living areas may be prevented are known (=flyscreens). DE 3045723 describes for example net curtains, nets, filters or sieves for such a purpose that are attached to window or door frames by means of press studs. Owing to their relatively large mesh sizes of 1-2 mm, these possess good visual transparency and provide the living areas with adequate airing, but the comparatively large mesh size does not provide adequate protection against pollen (size about 10-50 μm) and fungal spores (size about 200 μm).

Filtration means whereby air is completely cleaned of pollen, germs and spores find use in airconditioning and automobiles. The high filtering effect is achieved in DE 3904623 for example through the use of single- or else often multi-ply filter mats formed from nonwovens which, owing to their fibrous nature, make the filter stage impassable to the abovementioned allergens. To intensify the contact of the particle-laden air with the filter, the laminate of filter mats is additionally folded in a zigzag shape. However, owing to their nonexistent visual transparency, such filter mats have no utility as a protective or guard apparatus within the meaning of the present invention.

It is further possible to remove pollen from air flowing into an indoor amenity by means of a woven or loop-formingly knitted fabric solely by adjusting the mesh size. The sizes of most of the allergenic pollens occurring in Europe, essentially birch, grasses, goose-foot, wormwood, plantain, hazel, are in the region of 20-40 μm. The maximum feasible mesh size for purely mechanical filtration is therefore 20 μm, and this is too small to provide visual transparency.

A further window guard against pollen, germs and spores is disclosed for example in DE 4300422. A textile material is attached in front of the windowpane, not over the whole area thereof, but in the two wedgelike interstices and also the rectangular opening at the upper side of a window in tilt position. This form of attachment circumvents the problem of the nonexistent visual transparency of the textile material, but to completely open the window for airing purposes the textile material has to be removed, so that there is no longer any protective effect.

The cited examples show that heretofore the properties of adequate visual transparency, air perviousness and filtration have not been achieved in a single protective system.

It is an object of the present invention to actualize the properties of air perviousness, visual transparency and adequate filtering effect with regard to pollen in one protective system. The pollen protective system or guard shall combine an adequate filtration performance of 70-80% with regard to pollen and the like in the size region of about 20-40 μm with adequate ventilation and adequate visual transparency. Air perviousness and visual transparency are particularly important for living and working areas, since the air change rate on the one hand and the ability to allow people inside to look out and the letting in of daylight on the other all have to be ensured. Good values of air perviousness for acceptable ventilation of a room are of the order of not less than 20 000 m³/m²/h given a differential pressure of 300 Pa. Adequate transparency within the meaning of the invention is a transmission between 20 and 100%. The properties of adequate visual transparency and air perviousness are achieved through the use of a woven or loop-formingly knitted fabric having a sufficiently large mesh size. The contrary property of an adequate filtering effect is achieved by applying a triboelectric charge to support the purely mechanical filtering effect after the fabric has been placed in front of the window or door opening. A similar approach is disclosed in DE 4414728, where the charging of net-shaped wovens in synthetic high-polymeric fibers is used to create between the allergen and the fabric an electric field which is to be utilized for filtration. However, no details are provided as to how the electrostatic charge is supposed to be applied, nor of the relationship between the contrary properties of air perviousness and visual transparency on the one hand and filtration efficiency on the other.

The principle of applying a triboelectric charge is based on the separation of charges, brought about on a macroscopic scale by rubbing or separating at least two materials. The sign and the magnitude of the charge are determined initially by the escape energies Wₑ of the near-surface electrons of the materials, since near-surface electrons escape from the surface of one material and pass into that of the other. Consequently, an electron deficiency will develop in the surface of one material, causing this surface to become positively charged, whereas the other surface acquires a negative charge due to the excess electrons. It is discernible from Lüttgens/Glor: Elektrostatische Aufladungen begreifen und sicher beherrschen; 2nd edition, that for very rapid and high charging of the materials, as envisioned in the invention, the difference in their electron escape energies has to be very large.

As well as the electron escape energies, other parameters affecting a process of triboelectric charging are such as the temperature, roughness and degree of contamination of the surfaces, the rubbing or separating speed and also the humidity.

The discharging of the electrostatic charge is suppressed when the volume resistance, and also the surface resistance, of the materials is of the order of 10¹²-10¹⁵ Ω. The woven or loop-formingly knitted fabric therefore preferably utilizes fibers, or coatings applied to the fabric, having surface resistances of 10¹²-10¹⁵ Ω.

Electrostatic charging by charge separation may be effected for example by the rapid removal of a polymeric film attached to the fabric, on either or both sides, over the whole area thereof without air inclusions. Charging is likewise possible by the friction of particle-laden air against the fabric when air is passed at high speed through the fabric by means of a hand-held hair-dryer, an industrial air blower, including a hand-held industrial air blower, a ventilator or a fan.

The preferred way for the purposes of the present invention is the manual rubbing of a polymeric or natural material against the fabric after it has been attached in front of the window.

In the present invention, the electrostatic charge is not applied by applying an external voltage. Nor is the maintenance of the charge achieved by the external application of voltage, but solely through the triboelectric charging and the choice of the polymeric properties. In the event of a discharge occurring, for example as a result of increased atmospheric humidity or rain, the charge can be reestablished after the precipitation by drying and subsequent rubbing with the appropriate polymeric material. Another possibility is to dry and recharge in one operation, solely by using a hair-dryer to blow particle-laden air through the fabric.

What is claimed is:

1. The use of woven or loop-formingly knitted fabrics for attachment in front of windows or doors to guard against dusty allergens such as pollen or dust, this pollen guard possessing by virtue of the generation of an electrostatic charge an adequate filtering performance with regard to pollen while at the same time meeting the properties of adequate visual transparency and adequate air perviousness.

2. The use of claim 1, wherein the generation of the electrostatic charge is effected by rubbing a material against the fabric.

3. The use of claim 1, wherein the generation of the electrostatic charge is effected by blowing air through the fabric using industrial air blowers, including hand-held blowers, hand-held hair-dryers, ventilators or fans.

4. The use of claim 1, wherein the generation of the electrostatic charge is effected by removing a polymeric film attached to the fabric over the whole area thereof.

5. The use of claim 1, wherein the fibers of the pollen guard consist of one or more pure or heteroatom-containing hydrocarbons and have a surface resistance between 10¹² and 10¹⁵ Ω.

6. The use of claim 1, wherein the coating of the fabric consists of one or more pure or heteroatom-containing hydrocarbons and has a surface resistance between 10¹² and 10¹⁵ Ω.

7. The use of claim 1, wherein the diameter of the threads of the pollen guard is between 50 and 1 000 μm.

8. The use of claim 1, wherein the open area of a mesh is between 300 and 90 000 μm².
